(19) United States
(12) Patent Application Publication
(10) Pub. No.: US 2009/0011815 A1
(43) Pub. Date: Jan. 8, 2009

(54) GAMING MACHINE WITH BONUS GAME

(75) Inventor: John Stergides, London (GB)

Correspondence Address: BARLOW, JOSEPHS & HOLMES, LTD., 101 DYER STREET, 5TH FLOOR, PROVIDENCE, RI, 02903, US

(73) Assignee: ELECTROCOIN LEISURE (S. WALES) LTD., London (GB)

(21) Appl. No.: 11/574,426

(22) PCT Filed: Sep. 7, 2005
(86) PCT No.: PCT/GB2005/003447

§ 371 Date: Sep. 16, 2008

(30) Foreign Application Priority Data
Sep. 7, 2004 (GB) 0419804.0

(51) Int. Cl. A63F 9/24; A63F 13/00

(52) U.S. Cl. 463/20

(57) ABSTRACT

A basic fruit machine simulator apparatus (10) is associated with a feature game apparatus (20), so that the feature game may be played when a score above a predetermined threshold is achieved in the basic game. The feature game includes a display (21) showing a dial having a movable pointer (23) and a blocked off zone (24), and divided into sections by dividers (22). The sections are selectively denoted as prize winning and non winning zones, and the outcome is determined by which ever zone the pointer comes to rest in. The pointer may be stopped at, or rebound from the blocked off zone (24). The fruit machine display (15) is driven by a simulator (32), and the dial display (21) is driven by a simulator (34).

This invention relates to amusement and gaming apparatus adapted for playing of a feature or stand-alone game.

The invention relates in particular to electronic amusement and gaming apparatus for playing such games with prizes wherein the outcomes of games are generated randomly or by random controlled compensator by electronic apparatus, and a display is included which simulates operation of a mechanical analogue of the apparatus or on a video screen.

Amusement and gaming apparatus with a feature game are a development of the basic arcade “fruit machine” which is well known incorporating a plurality of reels, usually three, behind a panel with a window through which parts of the reels could be viewed. Each reel carried a plurality of symbols, and the object of the game was to stop the reels, which were set spinning, in such a way that prescribed combinations of matching symbols, are displayed at the window.

Such prescribed winning combinations of symbols include alignment of the same symbols on the middle line or any other winning combination, and diagonal alignments of matching symbols or any other line, with different values being allotted to certain symbols or any other winning combination. Because of legal requirements in the UK and other countries, concerning payment of winnings, the basic “fruit machine” has been elaborated into amusement and gaming apparatus with feature games i.e. a second stage game with a separate display panel which can be entered into, and advanced in accordance with scoring in the basic fruit machine game.

Another type of amusement and gaming apparatus of interest is the fairground ‘wheel of fortune’ game, where a large disc is rotated on a horizontal axis, and detents near the periphery of the wheel repeatedly catch a retarding device such as a leaf spring to bring the wheel to rest apparently at random. The wheel may be marked out into a large number of segments, each for example denoted by a number or indicating a prize or non-prize. In a variation players may make wagers concerning which numbered segment a pointer will indicate when the wheel is brought to rest, the winner being the one who has selected the indicated number. If there is no wager on the indicated number, of course the operator or “house” wins.

It is known to provide an amusement or gaming apparatus which electronically simulates the basic wheel of fortune game.

An object of the present invention is to provide an amusement or gaming apparatus adapted for playing a feature game as a second stage or a normal game to for example a so called fruit machine game, which is adapted for the playing of a novel game.

Accordingly to the invention, amusement or gaming apparatus comprises first electronic simulation apparatus for simulating the playing of a fruit machine game, and first display means providing a display which simulates a display window or video of a fruit machine, to display the game as simulated by the first electronic simulation apparatus, second electronic simulation apparatus for simulating the playing of a feature game, and second display means providing a second display which simulates a display of a feature game, characterised in that the second display comprises a simulated dial, a simulated pointer pivoted at the centre of the dial, and variable means for swinging said pointer to rotationally sweep the dial between a starting position and a finishing position, the finishing position being determined by the setting of the variable means.

The simulated dial may be divided to indicate prize winning and/or non-prize winning zones of the dial, indicating whether a prize will be won if the simulated pointer's finishing position falls in any particular zone.

A part of the dial may be blocked off e.g. an in angular segment bounded by two radii of the dial and the perimeter of the dial.

The pointer may be adapted to be subjected to any if the following effects if it should be moved with a force determined by the setting of the variable means which would cause the pointer to pass beyond the boundary of the blocked off segment, i.e.:—
1. It may simply stop at the boundary of the blocked off segment.
2. It may “rebound” or “bounce” i.e. return in the opposite sense and travel by the angular distance which it would have traveled in the initial sense if the boundary had not been there.
3. It may “rebound” with reduced force, and travel by an angular distance less than that which it would have traveled in the initial sense if the boundary had not been there, i.e. as if some of its kinetic energy had been absorbed by the boundary.
4. It may “rebound” with increased force and travel by an angular distance more that which it would have traveled in the initial sense if the boundary had not been there, i.e. as if it have been given a “kick” and gained kinetic energy by the boundary acting as a bat.

Which of the outcomes occurs and the amount by which a retardation or a boost effects the ‘rebound’ of the pointer may be determined randomly by the simulation programme with each individual play operation or be predetermined by the program.

The setting of the variable means may be determined by the manner in which an actuator button is pressed (e.g. the duration, or the force of the pressure exerted) or by means of a potentiometer, variable resistor, truck ball, sencor, pressure pad or any other device which can be the use can give a variable result.

The feature game may be arranged to be initiated by achievement of a score above a prescribed level in the fruit machine game, and the second simulator means may be enabled by a signal from the first simulator means on such a score being achieved. The player may be invited, by lighting up of a display, or display of a text message on a screen, to press the start button for the feature game for a possible bonus win.

The sections of the dial may indicate prize zones and non-prize zones, and possibly higher and lower prizes on different zone. The dial may be or a shape other than circular, e.g. square or polygonal (such as octagonal). In a modification, the player may be invited to nominate one or more zones in which he guesses the pointer may finish.

A single feature game apparatus may be provided for a group of basic game machines, that is two or more machines may activate a single feature game under prescribed conditions.

An embodiment of amusement and/or gaming apparatus with feature game accordingly to the invention will now be described by way of example, with reference to the accompanying drawings wherein:—

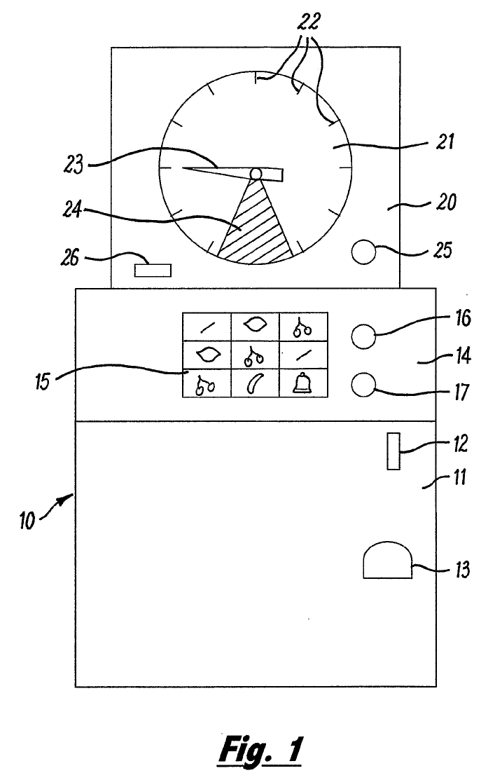

FIG. 1 is an elevational view of an embodiment of amusement apparatus according to the invention, and

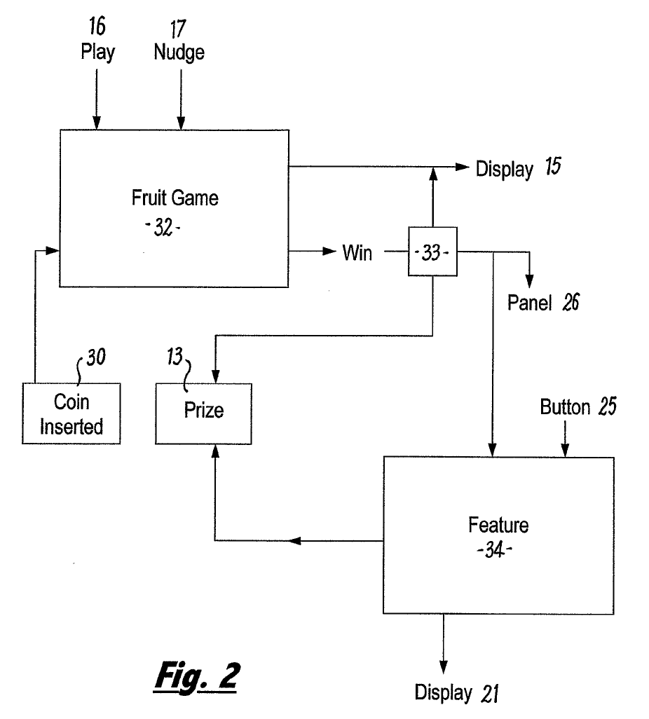

FIG. 2 is a block diagram of the operating system of the amusement apparatus of FIG. 1.

The amusement and/or gaming apparatus according to the invention, a front elevation of which is shown in FIG. 1, comprises a cabinet 10, having a base portion 11 which includes coin or token handling mechanisms of the usual type, including a payment slot 12 where coins or tokens are inserted before playing a game, a pay out or prize slot 13, and apparatus (not shown) within the base 11 for storage of coins and payout of prizes (which may be cash, tokens or goods). The arrangements of this part of a coin operated amusement or gaming machine are well known in the art and will not be further described.

A centre panel 14 provides a display window 15 for a fruit machine game, with associated control buttons, such as ‘play’ button 16 and ‘nudge’ button 17. The panel houses a device for simulating a standard fruit machine game, instead of the mechanical apparatus of three wheels with associated drives and brakes. The game is electronically simulated, and the nine segments of the window 15 display both the ongoing sequence of images generated by the simulation, and the result achieved when a randomly-generated stop signal freezes the simulation and a stationary result image is displayed at each window, so that each window displays one of the standard fruit machine images, such as cherrys, bells, etc. A win and its value is determined by standard fruit machine rules, e.g. consisting of three identical symbols on each of the panels of the middle horizontal line of panels, or identical images arranged diagonally. Certain specific images are considered to have a higher value then others, and the prize awarded is governed by these relative values.

In addition, the apparatus is adapted to, e.g. when a prize winning combination is indicated, offer access to a so-called feature game, and a display for this is embodied in an upper panel 20 of the front of the apparatus. This includes a circular display screen 21, exhibiting a dial marked into peripheral sections by dividing lines 22, and with a swing hand or pointer 23 rotable about a central boss of the dial. The screen 21 further has a differentially coloured part 24, which provides an excluded or blocked off zone, and comprises a sector between two radii of the dial.

The upper panel 20 also features a play button 25 and a message screen 26 which may amongst other possible functions indicate that the feature game is available to be played.

FIG. 2 is a block diagram illustrating the operation of the apparatus. Coin payment is made through the shot 12 in the panel 11, and sensors detect that a coin has been inserted so that a ‘coin inserted’ circuit 30 is triggered and sends an enabling signal to the fruit game simulator 32, which then operates in accordance with its programme when play button 16 is pressed. The simulator 32 drives the display which appears on the screen 15, which comprises a matrix of nine (3×3) sections which during operation of the simulator 32 display a series of standard fruit machine symbols as would a mechanical machine with rotating reels, until the reels are brought to a halt by a variable timer incorporated in the simulator, or by intervention by the player.

The result is displayed on the screen 15, and win or lose is assessed accordingly to rules written into the operating programme of the simulator, which preferably match the conventional rules of a fruit machine game. If a win is assessed a win driver 33 is activated and this triggers the prize giving mechanism in the base of the machine to pay out an appropriate prize, and also enables a feature simulator 34 and the message panel 26 on the top part of the machine. This message may simply read ‘PLAY NOW’ for example.

When the enabled feature simulator 34 is actuated by the start button 25, it drives the display 25, showing appropriate rotation of the pointer 23 until it is brought to rest. The pointer 23 is deemed by the simulator to be given an initial impetus, which may be determined by the force and duration of the player's pressure on the button 25, or determined arbitrarily by the simulator program. The pointer then rotates through an angle determined by the force, from its starting direction (which is arbitrary, or where it finished after the last previous play). The program will bring the pointer to rest after an interval of time which depends upon the initial impetus. This may be such as to traverse the pointer into the blocked off zone 24 of the dial. Where this occurs, the pointer does not enter the blocked off zone, but instead is arbitrarily subjected to any one of four possible outcomes, that is either it simply stops at the boundary of the blocked off zone 24, it may “rebound” or “bounce” i.e., returns in the opposite sense and may travel by an angular distance equal to that which it would have traveled if the boundary had not been encountered. It may “rebound” with reduced force, and travel by an angular distance less than that which it would have traveled if the boundary had not been encountered, as if some of its kinetic energy had been absorbed by the boundary; or it may “rebound” with increased force and travel by an angular distance greater than that which it would have traveled of the boundary had not been encountered, as if additional kinetic energy had been applied as a “kick”.

The pointer 25 will eventually come to rest, if necessary after one or more rebounds on a section of the dial between two lines 22. Certain of these sections are deemed to ‘winning’ sections, with various prizes associated there with the so-deemed sections. If the pointer finishes in one of these, a win enabler is triggered which actuates a visual display, and dispensing of the appropriate prize from slot 13.

An alternative play mode, which may be made available separately or alongside the first, is for the player to guess which sections of the pointer will finish in, and nominate one or more sections, with a win being assessed on the success or otherwise of the prediction.

The feature game described may also be provided as a “stand-alone” game.

1. Amusement or gaming apparatus comprising first electronic simulation apparatus for simulating the playing of a fruit machine game, and first display means providing a display which simulates a display window or video of a fruit machine, to display the game as simulated by the first electronic simulation apparatus, second electronic simulation apparatus for simulating the playing of a feature game, and second display means providing a second display which simulates a display of the feature game, characterised in that the second display comprises a simulated dial, a simulated pointer pivoted at the centre of the dial, and variable means for swinging said pointer to rotationally sweep the dial between a starting position and a finishing position, the finishing position being determined by the setting of the variable means.

2. Apparatus according to claim 1, wherein the simulated dial of the second display means is divided to indicate one of prize-winning and non prize winning zones of the dial, indicating whether a prize will be won if the simulated pointer's finishing position falls in any particular zone.

3. Apparatus according to claim 2 wherein part of the simulated dial is blocked off.

4. Apparatus according to claim 3 wherein said blocked off part comprises angular segment of the dial bounded by two radii and the perimeter of the dial.

5. Apparatus according to claim 3 wherein said second electronic simulation apparatus is operative to simulate the pointer being subjected to any of a plurality of effects.

6. Apparatus according to claim 5 wherein said effects include a) that the pointer simply stops at the boundary of the blocked off segment; b) the pointer “rebounds” by returning in the opposite sense and either travels a greater, a lesser or an equal distance to that which it would have traveled in the initial sense if the boundary had not been there.

7. Apparatus according to claim 6 wherein said second electronic simulation apparatus randomly selects between said effects with each play.

8. Apparatus according to claim 1, wherein the variable means has a setting which is determined by the manner in which an actuator button is pressed.

9. Apparatus according to claim 1 wherein the setting of the variable means is determined by means of any one of a potentiometer, variable resistor, truck ball, sensor, or pressure pad.

10. Apparatus according to claim 1 including means whereby the feature game may be initiated by achievement of a score above a prescribed level in the fruit machine game.

11. Apparatus according to claim 10 wherein there are means to enable the second simulation apparatus by applying a signal from the first simulation apparatus when such a score is achieved, to enable the second simulation apparatus.

12. Apparatus according to claim 10 provided with a display, which is activated to indicate that the feature game is available for playing.

13. Apparatus according to claim 1 wherein a single feature game apparatus is provided for a group of two or more fruit machine apparatuses.

14. Apparatus according to claim 1, wherein the second simulation apparatus is programmed to allow a player to predict one or more zones of the dial wherein the pointer will finish.
